(19) United States
(12) Patent Application Publication
(10) Pub. No.: US 2017/0093282 A1
(43) Pub. Date: Mar. 30, 2017

(54) Power Converter with Low Threshold Voltage Transistor

(71) Applicant: THE SILANNA GROUP PTY LTD., Eight Mile Plains (AU)

(72) Inventor: Yashodhan Vijay Moghe, Marsfield (AU)

(21) Appl. No.: 14/871,812

(22) Filed: Sep. 30, 2015

(51) Int. Cl. H02M 3/158

(52) U.S. Cl. CPC H02M 3/158

(57) ABSTRACT

A power converter with a high side transistor and a low side transistor produces a phase voltage as the high and low side transistors turn on and off under control of a high side driver and a low side driver, respectively. The low side transistor has a low threshold voltage of 0.4 volts or less. In some embodiments, a drive voltage less than 0 volts turns off the low side transistor. In some embodiments, a low impedance between the low side driver and the low side transistor enables the drive voltage to turn off the low side transistor during high output transients. In some embodiments, the high side transistor, the low side transistor, the high side driver, and the low side driver are integrated together on the same integrated circuit die.

### BACKGROUND OF THE INVENTION

Some types of power converters for providing electrical power to electronic devices have a power switch with a high side power transistor and a low side power transistor that are rapidly switched on and off in order to produce a current at a desired voltage (the phase voltage) at a node (the phase node) between the two transistors. The phase voltage is used to produce an output voltage that is provided to the load of the electronic device.

A typical design concern involves the potential for a drain-gate capacitance of the low side transistor (usually an nFET with a drain connected to the phase node) to turn the low side transistor on transiently when the high side transistor pulls the phase node to a high voltage, particularly during a fast output transient. This condition, wherein the low side transistor turns on while the high side transistor is also turned on, is commonly called the “shoot-through” problem. The shoot-through problem is a short-circuit that results in a very large power loss and potentially permanent damage to the power converter circuitry.

To prevent the shoot-through problem, the low side transistor typically requires a threshold voltage that is high enough to ensure that the transient rise in gate voltage does not turn it on. There is a tradeoff in the level of the threshold voltage, however, due to the fact that a higher threshold voltage results in higher power losses and requires a larger overall physical dimension for the switch.

The threshold voltage (Vt) is the minimum gate electrode bias required to strongly invert the surface under the gate poly and form a conducting channel between the source and the drain regions. Common values for Vt are 2-4 volts for high voltage devices with thicker gate oxides, and 1-2 volts for lower voltage, logic-compatible devices with thinner gate oxides. With power MOSFETs finding increasing use in portable electronics and wireless communications where battery power is at a premium, the trend is toward lower values of Ron and Vt with a common value for Vt of about 1 volt.

### SUMMARY OF THE INVENTION

In some embodiments, a power converter includes a high side transistor, a low side transistor, a high side driver, and a low side driver. The low side transistor is connected to the high side transistor and has a threshold voltage of about 0.4 volts or less. The high side driver is connected to the high side transistor to turn on and off the high side transistor. The low side driver is connected to the low side transistor to turn on and off the low side transistor. The high side transistor and the low side transistor produce a phase voltage.

In some embodiments, a method involves turning on a high side transistor to connect a phase node to a high voltage, while a low side transistor having a threshold voltage at 0.4 volts or less is off; turning off the high side transistor; turning on the low side transistor to connect the phase node to a low voltage while the high side transistor is off; turning off the low side transistor; and repeating the method to generate a phase voltage at the phase node.

In some embodiments, a drive voltage produced by the low side driver to turn off the low side transistor is less than 0 volts. In some embodiments, the high and low side transistors and the high and low side drivers are integrated together on a same integrated circuit die. In some embodiments, a source of the drive voltage is also integrated on the same integrated circuit die. In some embodiments, the drive voltage turns off the low side transistor during transients in the phase voltage that have a rise time of 5 ns or less. In some embodiments, the drive voltage is less than −4.75 volts. In some embodiments, an impedance between the low side driver and the low side transistor is 0.5 Ohm or less.

### BRIEF DESCRIPTION OF THE DRAWINGS

FIG. 1 is a simplified electronic schematic diagram of an example electronic device incorporating an embodiment of the present invention.

FIG. 2 is a simplified electronic schematic diagram of an example power switch for use in the example electronic device shown in FIG. 1 in accordance with an embodiment of the present invention.

FIG. 3 shows a simplified layout diagram of an example power switch in accordance with an embodiment of the present invention.

FIG. 4 shows a simplified layout diagram of an alternative power switch in accordance with an embodiment of the present invention.

FIG. 5 is a simplified electronic schematic diagram of an example power switch in accordance with an embodiment of the present invention.

FIG. 6 shows a simplified electronic schematic diagram of a gate driver/FET segment for use in the power switch shown in FIG. 4 in accordance with an embodiment of the present invention.

FIG. 7 shows example transient response graphs of a prior art power FET.

FIG. 8 shows example transient response graphs of a power FET in accordance with an embodiment of the present invention.

FIG. 9 shows a simplified layout diagram of another alternative power switch in accordance with an embodiment of the present invention.

FIG. 10 shows a simplified layout diagram of another alternative power switch in accordance with an embodiment of the present invention.

FIG. 11 shows a simplified layout diagram of another alternative power switch in accordance with an embodiment of the present invention.

FIG. 12 shows a simplified layout diagram of another alternative power switch in accordance with an embodiment of the present invention.

### DETAILED DESCRIPTION OF THE INVENTION

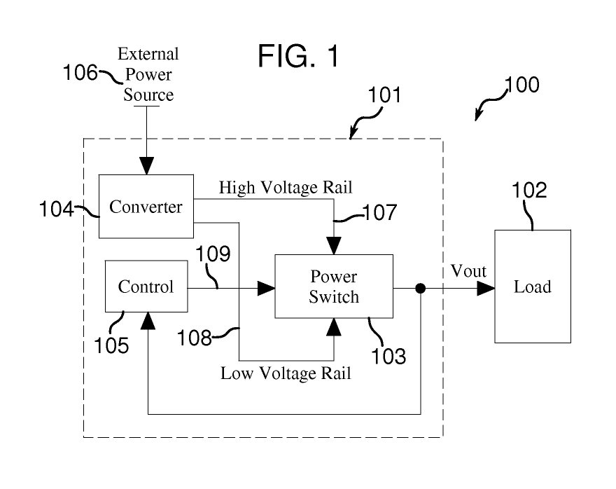

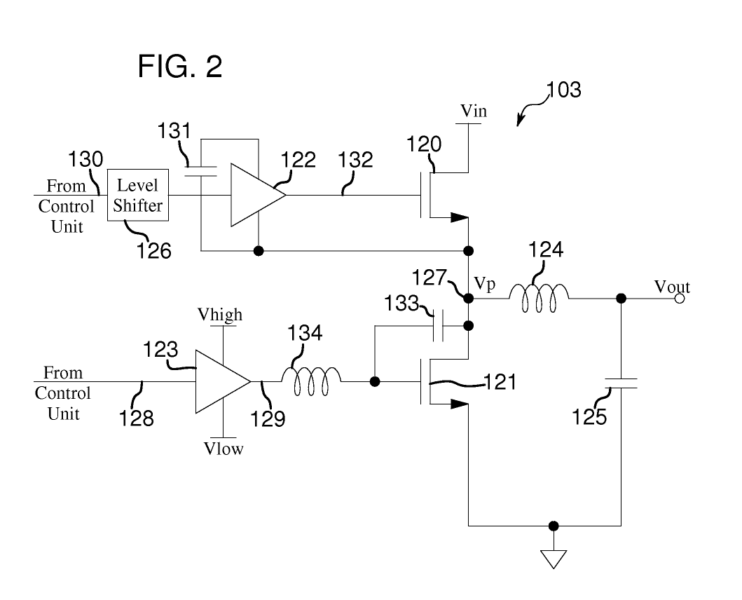

An example electronic device 100 is shown in FIG. 1 having a power converter 101 that provides regulated power with an output voltage Vout to a load 102 (i.e., representing circuitry for performing the functions of the example electronic device 100) in accordance with an embodiment of the present invention. In some embodiments, the power converter 101 is integrated on a single integrated circuit (IC) die or chip. In other embodiments, some components of the power converter 101 are provided on separate IC dies in a multi-chip package or separate IC packages. In the illustrated embodiment, the power converter 101 includes a power switch 103, a converter 104, and a control unit 105. The power switch 103 further includes high and low side power transistors operated by high and low side gate drivers (see FIG. 2 below). The integration of the power transistors, the drivers, and the converter 104, particularly for embodiments integrated on a single IC die, enable the threshold voltage (Vt) of the low side transistor to be relatively low, while still being able to keep the low side transistor off during a fast output transient, e.g., having a 5 ns rise time or less.

In various embodiments, the converter 104 is integrated on the same IC die (e.g., an on-chip DC-DC converter) that contains the components of the power switch 103 or is provided on a separate die. The converter 104 receives power from an external power source 106, such as a battery or AC-DC converter. The converter 104 generates a high voltage for a high voltage rail 107 and a low voltage for a low voltage rail 108. The high and low voltage rails 107 and 108 connect to the power switch 103 to power the gate drivers, as described below.

In various embodiments, the control unit 105 is integrated on the IC die containing the components of the power switch 103 or provided on a separate die. The control unit 105 generates control signals on lines 109 that connect to the power switch 103 to control the gate drivers, as described below. The control unit 105 also receives a feedback signal indicative of the level of the output voltage Vout, so that the control unit 105 can adjust the duty cycle of the control signals on the lines 109 to ensure that the output voltage Vout is maintained at about a desired level.

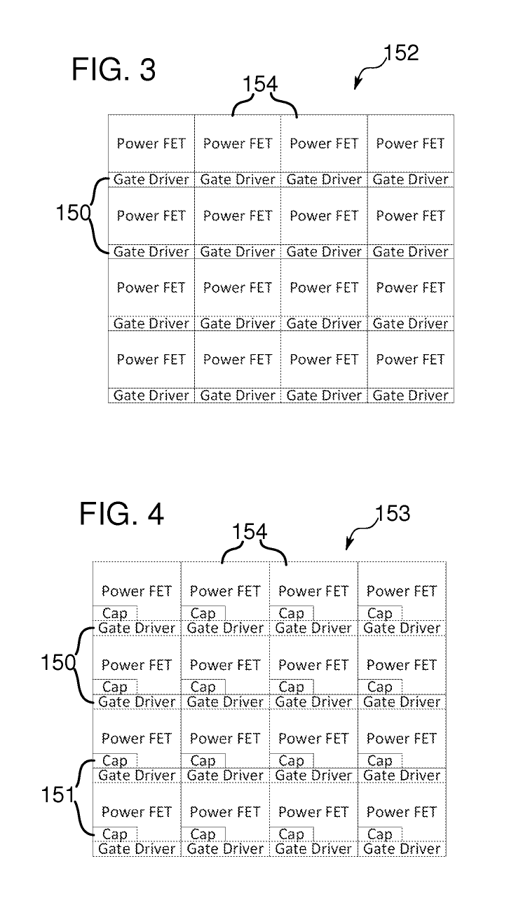

In some embodiments, the example power switch 103, as shown in FIG. 2, is a continuous current buck converter with high and low side power transistors (e.g., MOSFETs) 120 and 121, high and low side gate drivers 122 and 123, an output inductor 124, an output filter capacitor 125, and a level shifter 126 connected together as shown, among other components not shown for simplicity. The power transistors 120 and 121 are shown as nFETs (n-channel MOSFETs). However, in some embodiments, the high side power transistor 120 is a pFET (p-channel MOSFET). In some embodiments, the transistors 120 and 121 and the drivers 122 and 123 are integrated on the same IC die, as described below with reference to FIGS. 3-12. In other embodiments, the transistors 120 and 121 are integrated on one IC die, and the drivers 122 and 123 are integrated on another IC die.

In the illustrated embodiment, the power transistors 120 and 121 are connected at a phase node 127 between a source of the high side power transistor 120 and a drain of the low side power transistor 121. A drain of the high side power transistor 120 connects to an input voltage Vin, e.g., from the external power source 106 (FIG. 1). A source of the low side power transistor 121 connects to a ground or reference voltage. When the high side power transistor 120 is turned on (and the low side power transistor 121 is turned off), a phase voltage Vp at the phase node 127 is pulled up to the input voltage Vin. When the low side power transistor 121 is turned on (and the high side power transistor 120 is turned off), the phase voltage Vp is drawn down to ground. This repeated cycling of the phase voltage Vp charges and discharges the output inductor 124 to produce the output voltage Vout. The output filter capacitor 125 smooths out oscillations in the output voltage Vout.

In some embodiments, the low side power transistor 121 is an nFET with a relatively low threshold voltage Vt of about 0.4 volts or less. In other embodiments, the threshold voltage Vt of the low side power transistor 121 is zero (e.g., for an intrinsic mode power FET) or negative (e.g., for a depletion mode power FET).

A control signal on line 128, in the illustrated embodiment, is provided to a control input of the low side gate driver 123, and a high voltage Vhigh and a low voltage Vlow are provided to high and low power inputs, respectively, of the low side gate driver 123. The control signal on line 128, for example, is one of the control signals on lines 109 (FIG. 1). The high and low voltages provided through the high and low voltage rails 107 and 108 (FIG. 1) serve as voltage sources for the high voltage Vhigh and the low voltage Vlow, respectively. Under control of the control signal on line 128, therefore, the low side gate driver 123 alternately produces or generates the high voltage Vhigh and the low voltage Vlow, i.e., a low side gate drive voltage, at an output to line 129 connected to the gate of the low side power transistor 121.

Application of the high voltage Vhigh to the gate of the low side power transistor 121, in the illustrated embodiment, turns on the low side power transistor 121 to connect a phase node 127 (at a drain of the low side power transistor 121) to ground (connected to a source of the low side power transistor 121). Application of the low voltage Vlow to the gate of the low side power transistor 121 turns it off to isolate the phase node 127 from the ground.

In the illustrated embodiment, a control signal on line 130 is provided to the level shifter 126, which converts the control signal on line 130 to an appropriate voltage level for application to a control input of the high side gate driver 122. The control signal on line 130, for example, is one of the control signals on lines 109 (FIG. 1). A low power input of the high side gate driver 122 is connected to the phase node 127, which is further connected through a bootstrap capacitor 131 to a high power input of the high side gate driver 122. Thus, the low power input of the high side gate driver 122 is tied to the phase voltage Vp at the phase node 127; whereas, the high power input of the high side gate driver 122 is floating. An output of the high side gate driver 122 is connected through a line 132 to the gate of the high side power transistor 120. The bootstrap capacitor 131 charges up when the phase voltage Vp is low, in a typical configuration, for example, it can be charged up to 5 volts. When the phase voltage Vp goes high, the bootstrap capacitor 131 tracks up with it. In this manner, under control of the level shifted control signal on line 130, the high side gate driver 122 produces or generates a high side gate drive signal or voltage at the output to line 132 to control the gate of the high side power transistor 120.

In other embodiments in which the high side power transistor 120 is a pFET (not shown), a floating ground configuration is used to power the high side gate driver 122. In this case, the high power input of the high side gate driver 122 is connected to the input voltage Vin, and the low power input of the high side gate driver 122 is tied to a voltage source that is about the input voltage Vin minus an appropriate voltage amount, e.g., about 5 volts. Again, under control of the level shifted control signal on line 130, the high side gate driver 122 produces a gate drive signal at the output to line 132 to control the gate of the high side power transistor 120.

In either example embodiment for the high side power transistor 120, turning on the high side power transistor 120 connects the phase node 127 (at a source of the high side power transistor 120) to the input voltage Vin (connected to a drain of the high side power transistor 120). Turning off the high side power transistor 120 isolates the phase node 127 from the input voltage Vin.

When the control signal on line 128 is set to turn on the low side power transistor 121, the high voltage Vhigh on the high voltage rail 107 is provided through the low side gate driver 123 to the gate of the low side power transistor 121. Due to the relatively low threshold voltage Vt of the low side power transistor 121, however, the voltage level required for the high voltage Vhigh to turn on the low side power transistor 121 is significantly less than that required in conventional designs, thereby reducing power consumption or power loss. For example, in some embodiments, a 1.8 volt gate drive voltage is used for a threshold voltage of 0.4 volts. On the other hand, using the same voltage level as in a conventional design (typically about 5 volts), but with the low threshold voltage Vt, enables turning on the low side power transistor 121 more strongly, thereby conducting more current and making the power switch 103 more efficient. In this manner, for example, it is possible to get about 30% extra current without increasing the physical dimensions of the power switch 103.

Additionally, the reduction of the threshold voltage Vt enables a lower “on” resistance (Ron) for the low side power transistor 121. Typically, a lower Ron requires a larger transistor device size. However, the lower threshold voltage Vt allows for either the lower Ron without increasing the size or layout of the low side power transistor 121 or the same Ron with a smaller size or layout of the low side power transistor 121. Therefore, the low threshold voltage Vt results in the advantages of lower Ron (and thus lower power consumption/loss) and/or smaller device size. In some embodiments, the size reduction due to the lower threshold voltage Vt is on the order of about 20%.

Also, the smaller device size results in a smaller gate capacitance associated with the low side power transistor 121. The smaller gate capacitance results in lower switching losses, since the switching loss is determined by the calculation of fCV̂2, where f is the switching frequency, C is the gate capacitance, and V is the gate drive voltage. On the other hand, since a lower voltage is needed to drive the low side power transistor 121, it is possible to make the gate oxide thinner. The thinner gate oxide leads to greater gate capacitance. Nevertheless, the reduced gate drive voltage still results in improved switching losses.

Furthermore, the ability to lower the Ron and/or gate capacitance (due to the smaller threshold voltage Vt) results in a lower Ron*Qg measure, i.e., the product of the on resistance Ron times the charge Qg required to charge up the gate to turn on the low side power transistor 121. The value of this product is considered a good or rough measure of how good the technology is for the power switch 103, with a lower value being considered better. In some embodiments, the Ron*Qg measure is lowered by about 10%.

Additionally, the size of the low side power transistor 121 is a significant design issue, since it typically takes up a large percentage of the overall size of the power switch 103. The large size of the low side power transistor 121 is generally due to the fact that the duty cycle (i.e., the fraction of the cycle time period that the high side is turned on) is usually low, since most applications operate with a relatively low Vout and relatively high Vin. Therefore, most applications typically require the low side power transistor 121 to be turned on for a much longer portion of the cycle time period than for the high side power transistor 120. Thus, the power losses associated with the low side power transistor 121 present a dominate design issue, which can be alleviated by making the resistance of the low side power transistor 121 as low as possible, e.g., on the order of about 1 milliohm. A low resistance, however, generally requires a larger size, e.g., on the order of about 5-15 millimeters square. Therefore, any reduction in the size of the low side power transistor 121 represents a significant reduction in the overall size of the power switch 103 and, thus, a reduction in cost.

A parasitic drain-gate capacitance Cdg 133 presents a potential shoot-through problem due to the relatively low threshold voltage Vt of the low side power transistor 121 and an inherent impedance (represented by a gate inductance Lg 134) between the low side gate driver 123 and the low side power transistor 121. If this situation were to occur, then when the high side power transistor 120 turns on (and the low side power transistor 121 is supposed to turn off), the phase voltage Vp at the phase node 127 would be quickly pulled up toward the input voltage Vin. The rapid rise in the phase voltage Vp, however, would couple to the gate of the low side power transistor 121 through the parasitic drain-gate capacitance Cdg 133, which would turn on the low side power transistor 121. Thus, a power draining short circuit would be caused between the input voltage Vin and the ground.

To prevent the shoot-through problem from occurring, the gate inductance Lg 134 (and a related gate resistance) is made as small as possible. Thus, a very low impedance for the low side gate driver 123, or a low impedance between the low side gate driver 123 and the low side power transistor 121, enables the low side drive voltage (low voltage Vlow) to keep the low side power transistor 121 off, even during high output transients, in spite of the low threshold voltage Vt. In some embodiments, this impedance is about 0.5 Ohm or less.

In some embodiments, the gate inductance Lg 134 is reduced by integrating the low side gate driver 123 and the low side power transistor 121 (as well as the high side gate driver 122 and the high side power transistor 120) together on the same IC die, as described below with reference to FIGS. 3-12. In this manner, the low side gate driver 123 and the low side power transistor 121 are formed relatively close to each other, thereby reducing the gate inductance Lg 134. Additionally, in some embodiments, since the low side power transistor 121 (as well as the high side power transistor 120) is typically formed as a plurality of individual FET segments distributed within the IC die, the low side gate driver 123 (as well as the high side gate driver 122) are also formed as a corresponding plurality of individual gate driver segments distributed within the IC die, as also described below. In this design, the gate driver segments are placed as close to the FET segments as possible, thereby further reducing the gate inductance Lg 134 (and related gate resistance).

With the low gate inductance Lg 134, when the phase voltage Vp increases rapidly, the effect on the gate of the low side power transistor 121 is insignificant or barely noticeable. Instead, the low voltage Vlow from the low side gate driver 123 to the gate is able to properly turn off the low side power transistor 121.

In some embodiments, the ability to turn off the low side power transistor 121 is further aided by making the low voltage Vlow significantly lower than the threshold voltage Vt, even negative. In this case, the converter 104 produces a low or negative voltage on the low voltage rail 108, i.e., it forms a negative power rail in some embodiments. In some embodiments, for example, a voltage level from about 0 or −1 volts to about −5 volts (i.e., less than −4.75 volts) is used for the low voltage Vlow, depending on the severity of the potential shoot-through problem.

This design is contrasted with conventional power switch designs in which a low side power transistor has a relatively low threshold voltage Vt, i.e., less than about 1 volt. The level of the threshold voltage Vt in these situations is limited by the difficulty of turning off the low side power transistor, even though some conventional designs may include a pull-down FET to ensure that the gate of the low side power transistor is pulled down to ground when turning it off. In other words, the threshold voltage must be high enough that zero volts on the gate can turn off the low side power transistor. It is thus only with embodiments of the present invention that the threshold voltage Vt for the low side power transistor 121 can be made as low as described herein and still be able to reliably turn it off and keep it off.

A more negative level is used in embodiments in which the power switch 103, the converter 104, and the control unit 105 are not all integrated together in the same IC die, since such embodiments typically have a greater gate inductance Lg 134 that must be overcome by the low voltage Vlow. A more highly integrated design, on the other hand, can use a less negative voltage level, since such designs typically have a lower gate inductance Lg 134. In some embodiments, therefore, the level of the low voltage Vlow depends in part on how highly integrated the design is. In general, however, it is easier to provide or maintain the negative gate drive voltage in the more highly integrated embodiments. In some embodiments, therefore, the converter 104 is an on-chip DC-DC converter integrated on the same IC die that contains the components of the power switch 103.

A potential problem with a negative gate drive voltage embodiment is that at power-on or startup the negative rail is not yet active. Thus, the low side power transistor 121 is conducting at this early stage, thereby risking an initial shoot through problem. This condition can be avoided with a startup circuit that inhibits switching on the power switch 103, until the negative rail is established.

The negative power rail feature is particularly useful for embodiments having an intrinsic (zero Vt) or depletion mode (negative Vt) power FET. To turn off such devices, a negative voltage on the low voltage rail 108 is used to supply the low voltage Vlow.

In some embodiments, the high side power transistor 120 has a low threshold voltage Vt, but the low side power transistor 121 has a conventional threshold voltage Vt. Again, if a negative drive voltage is used to turn off the high side power transistor 120, it may be necessary to provide for a means to prevent a power drain through the power transistors 120 and 121 at power-on, such as a startup circuit that inhibits switching on of the high Vt low side power transistor 121, until the high-side negative power rail becomes active.

In some embodiments of the present disclosure, a distributed layout for the gate drivers 122 and 123 and the power transistors 120 and 121 is created. In some embodiments, segments of the gate drivers 122 and 123 are interspersed among segments of the power transistors 120 and 121 on the semiconductor die. A supply-decoupling capacitance is also distributed among the gate driver segments to reduce Vdd and Vss inductance on the gate driver segments (which also effectively are in series with Ls). This decoupling capacitor may be placed on top of the active circuitry to save space, such as being placed in an interconnect layer(s) or a redistribution layer (RDL) or using a layer transfer technique. Alternatively, the decoupling capacitor may be adjacent to the active circuitry. In some embodiments, each decoupling capacitor segment corresponds to one of the plurality of gate driver segments, each decoupling capacitor segment being adjacent the corresponding one of the gate driver segments. In other embodiments, the gate driver segments and the power transistor segments are arranged as interdigitated fingers, and the decoupling capacitor segments are distributed along the gate driver segment fingers. In certain embodiments, at least part of the decoupling capacitor is located in a gate oxide layer of the semiconductor device. In other embodiments, the gate drivers 122 and 123 are fabricated within a horizontal area of the semiconductor die, and the decoupling capacitors are above the gate drivers 122 and 123 within the horizontal area, i.e., vertically aligned with the horizontal area of the gate drivers 122 and 123. In some embodiments, the decoupling capacitor segments are within 100 μm of the gate driver segments.

FIGS. 3 and 4 show example layouts of how gate driver segments 150 without (FIG. 3) and with (FIG. 4) decoupling capacitor segments 151 may be physically distributed on a die 152 or 153 in accordance with some embodiments. In FIG. 3, the gate driver segments 150 are interspersed between power FET segments 154. In this embodiment, the segments 150 and 154 are linear arrangements that are interdigitated between each other. The gate driver (i.e., segments 150) is thus distributed evenly throughout the power FET (i.e., segments 154). The distributed gate driver and FET elements may be distributed in various configurations, such as adjacent to each other in linear arrangements, as FET segments encircling gate driver segments, or gate driver segments surrounding FET segments.

FIG. 4 is similar to FIG. 3, but with the addition of each capacitor segment 151 adjacent to each power FET segment 154. The capacitance of the semiconductor die 152 or 153 is thus distributed among the gate driver (i.e., segments 150), such as one capacitor segment 151 for each gate driver segment 150 and power FET segment 154. In some embodiments, the gate driver (i.e., segments 150) is fabricated within a defined horizontal area of the semiconductor die 152 or 153, and the decoupling capacitor segments 151 are located above or below the gate driver segments 150. For example, the decoupling capacitor segments 151 may be vertically aligned with the horizontal area in some embodiments, such as being fabricated using inter-metal or RDL layers of the semiconductor die 152 or 153, and thus being located above the gate driver (i.e., segments 150). In other embodiments, the decoupling capacitor segments 151 may be adjacent to the gate driver segments 150, such as by using the gate oxide layer to make part of the decoupling capacitor segments 151.

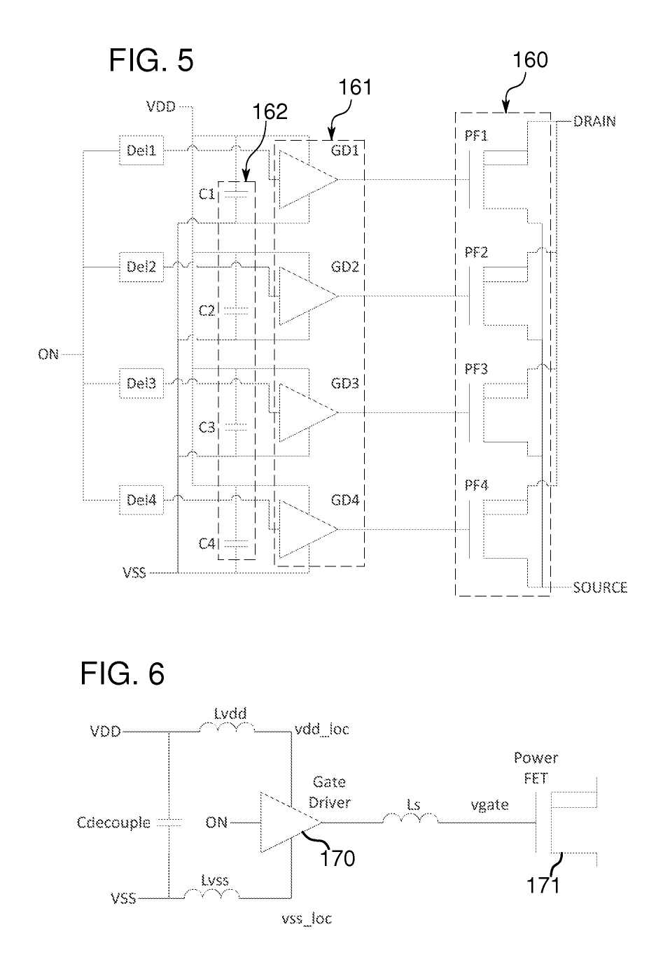

A schematic representation is shown in FIG. 5 for an example embodiment in which a power FET 160 (e.g., 120 or 121, FIG. 2) has four segments (for diagram simplicity). Additionally, a gate driver 161 (e.g., 122 or 123, FIG. 2) has four gate driver (GD1, GD2, GD3, GD4) segments, each associated with a power FET (PF1, PF2, PF3, PF4) segment. For example, the gate driver segments (GD1, GD2, GD3, GD4) can be fingers that are interspersed, such as by being interdigitated between the power FET segments/fingers (PF1, PF2, PF3, PF4). A decoupling capacitor 162 is distributed into four segments (C1, C2, C3, C4), each placed adjacent to one of the gate driver segments (GD1, GD2, GD3, GD4). Having the decoupling capacitance (which may also be referred in this disclosure to as “decoupling cap”) in close proximity to the gate driver 161 improves performance of the converter (e.g., power converter 101) by improving speed and reducing energy loss. It should be noted that no particular implementation of the gate driver 161, the power FET 160 or the decoupling cap 162 is implied by the schematic of FIG. 5. All of the different methods of implementing these elements are covered in this disclosure. For example, the power FET 160 may be a DMOS transistor, JFET, etc. The gate driver 161 may be a chain of inverters or buffers, a constant current source, etc. The decoupling cap 162 may be implanted using gate oxide, inter-metal capacitance, RDL layers, etc.

Optional delay elements (Del1, Del2, Del3, Del4) are also shown in FIG. 5, which can be used to control the delay between the different parts of the array switching on/off. This delay can be used beneficially, for example, to control the duration of the switch on/off transients in order to limit electromagnetic (EM) emissions, etc. The delay elements (Del1, Del2, Del3, Del4) may be implemented in any suitable fashion, such as transmission line, RC constant, inverter chain and the like.

The purpose of distributing the decoupling capacitance is understood by looking at the diagram FIG. 6, which provides a more detailed view of one pair of gate driver 170 (e.g., GD1, GD2, GD3, GD4) and power FET 171 (e.g., PF1, PF2, PF3, PF4) segments of FIG. 5 in accordance with some embodiments. In FIG. 6, Lvdd and Lvss represent the inherent inductance from wire conductors in the circuit—that is, the inductance in series with the supply and ground connection—where Vdd is the drain voltage and Vss is the source voltage. Even if the Ls is minimized by distributing the gate driver 161 (i.e., gate driver 170 is closer to the power FET 171, thus resulting in less inductance), Lvdd and Lvss will still act to limit how quickly the power FET 171 can be switched on and off. There are two main reasons why this occurs. Firstly, the decoupling capacitor Cdecouple acts as the energy reservoir to power the gate driver 170 itself, so during a sudden transient the local voltages vdd_loc and vss_loc can collapse if Lvdd and Lvss are too large. Secondly, for charging the gate of the power FET 171, a significant energy source is required (to charge several nF of capacitance on the gate), and the presence of Lvdd and Lvss limits the instantaneous current peak available to charge the gate of the power FET 171. To combat both of the problems above, the decoupling capacitor Cdecouple is distributed throughout the array alongside or on top of the bits of the gate driver 170. Distribution of the decoupling capacitor Cdecouple into the semiconductor die 153 may be achieved by forming the decoupling capacitor Cdecouple in, for example, the gate oxide, from metal-intermetal layers, redistribution layers, or bonding it on the semiconductor die 153. In some embodiments, part of the decoupling capacitor Cdecouple is fabricated in the gate oxide, which can provide a high-density capacitor. In other embodiments, the decoupling capacitor Cdecouple is fabricated in the inter-metal or RDL layers, being located above the semiconductor circuitry and saving chip area.

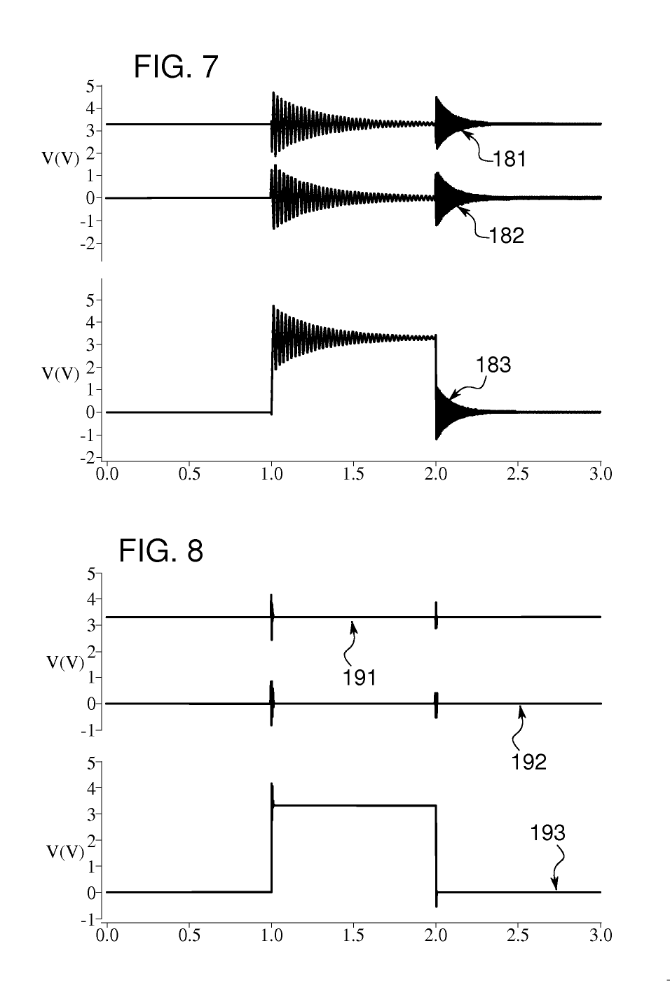

Simulations of transient responses of a power FET without a distributed capacitor and a power FET (e.g., 171) with a distributed capacitor (e.g., Cdecouple) are shown in FIGS. 7 and 8, respectively. In FIG. 7, a simulated case is shown where Lvdd and Lvss are set to 1 nH each. On-chip metal traces can be approximated as 1 nH/mm, for practical situations where the length of the trace is significantly larger that the width. Thus, the case in FIG. 7 represents an example where a conventional decoupling cap is 1 mm away from the gate driver/power FET array, which is actually an optimistic situation. As can be seen in FIG. 7, there is significant ringing on vdd_loc (top line 181), vss_loc (middle line 182) and vgate (bottom line 183) persisting for over 1 microsecond. That is, the local supply (vdd_loc/vss_loc) on the gate driver is collapsing transiently, which in turn causes oscillations on the power FET gate and a general slowing down of how quickly it can be switched on and off. Such ringing not only severely degrades the power conversion efficiency in a real application, but also generates significant EM interference that can affect nearby systems.

In comparison, the simulation of FIG. 8 shows an example embodiment in which the decoupling capacitor Cdecouple has been distributed, and where Lvdd and Lvss are 10 pH. For example, the distributed decoupling capacitor Cdecouple may be 10 μm away from the gate driver 170, which corresponds to 10 pH. As can be seen in FIG. 8, the transitions in the voltage responses (vdd_loc line 191, vss_loc line 192, and vgate line 193) are relatively clean by comparison with the example of FIG. 7 (corresponding lines 181, 182, and 183, respectively), with only small glitching lasting less than 1-2 nanoseconds. In various embodiments, the decoupling capacitor Cdecouple may be distributed to achieve inductances Lvdd and Lvss of less than or equal to, for example, 100 pH. That is, the decoupling capacitor Cdecouple may be within 100 μm from the gate driver 170. FIG. 8 clearly shows, therefore, that distributing capacitance with a gate driver for a power switch greatly reduces oscillations in the voltage response of a power FET, thus increasing the rate at which a power FET can be switched on and off and improving power conversion efficiency.

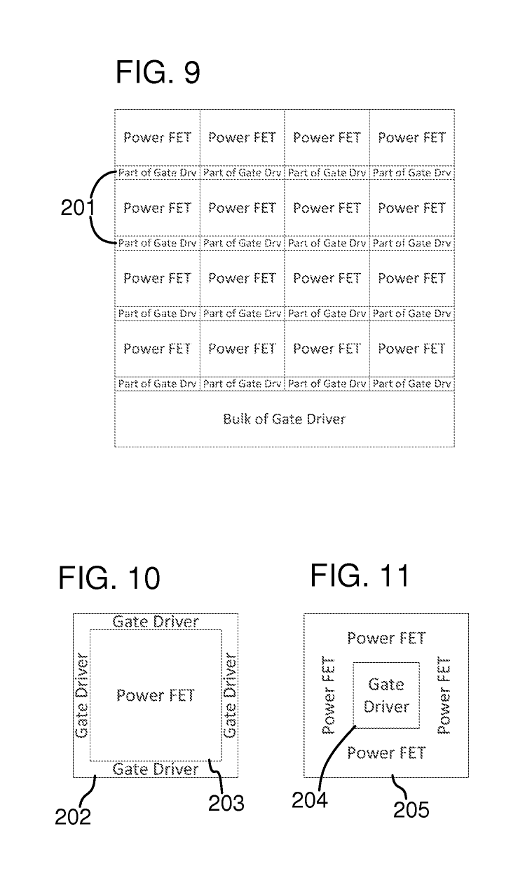

Another embodiment of distributing the gate driver is shown in FIG. 9. In this alternative implementation, provision has been made for distributing only part of the gate driver (segments 201), e.g. just the last stage or just one part of the last stage. In other embodiments, similar distribution layouts can be applied for distributing the decoupling cap throughout the array. In the embodiment of FIG. 9, it should be assumed that the decoupling capacitance is distributed along with the gate driver (segments 201), even though this is not explicitly shown in order to make the diagram more readable.

In conventional converters in which the driver/control circuitry and power device are implemented on the same die, when the power device turns off, a large amount of charge may dissipate into the substrate and potentially create noise in adjoining circuitry. In some embodiments of the present disclosure where the gate driver is distributed throughout the power FET, implementing the combined circuit on an SOI (silicon-on-insulator) die alleviates the noise issue because the charge from the power device does not dissipate and affect additional circuitry on the die.

Some or all of the embodiments described herein may be achieved on SOI-based processes. However, on some processes (e.g. bulk CMOS with trench isolation), some implementations may consume excessive area. The reason for this is that a certain spacing needs to be maintained between the power FET fingers and the gate driver fingers to avoid the twin problems of voltage breakdown and latch-up. In these cases, distributing only a part of the gate driver into the power FET layout is also possible, such as only distributing the N-half of the final stage of the gate driver driving a power NFET, or distributing the P-half of the final stage of the gate driver for a PFET.

Other geometries for distributing the gate driver or parts thereof are also possible, and beneficial in many situations. For example, distributing a gate driver 202 concentrically around the periphery of a power FET 203, as shown in FIG. 10, provides improved performance over a conventional gate driver sitting next to the power FET. In embodiments in accordance with FIG. 10, the effective inductance may be cut down by at least a factor of four.

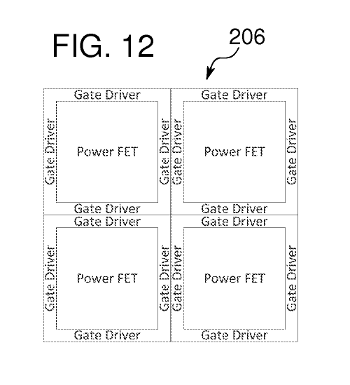

In some embodiments, as shown in the example layout of FIG. 11, the gate driver 204 is seated in the center and the power FET 205 is arranged concentrically around it. Both concentric geometries (FIGS. 10 and 11, gate driver 202 or 204 on the inside or the outside of the power FET 203 or 205) give a similar reduction in Ls. Some embodiments having other geometric arrangements will be readily apparent, such as an array 206 of smaller concentric arrangements as shown in FIG. 12.

Reference has been made in detail to embodiments of the disclosed invention, one or more examples of which have been illustrated in the accompanying drawings. Each example has been provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

Although embodiments of the invention have been discussed primarily with respect to specific embodiments thereof, other variations are possible. Various configurations of the described structures or processes may be used in place of, or in addition to, the configurations presented herein.

Those skilled in the art will appreciate that the foregoing description is by way of example only, and is not intended to limit the invention, except where explicitly stated. Nothing in the disclosure should indicate that the invention is limited to systems that are implemented in a single circuit. Nothing in the disclosure should indicate that the invention is limited to systems that require a particular type of integrated circuit. Nothing in the disclosure should limit the invention to particular semiconductor devices. In general, any diagrams presented are only intended to indicate one possible configuration, and many variations are possible. Those skilled in the art will also appreciate that methods and systems consistent with the present invention are suitable for use in a wide range of applications encompassing electronic circuits.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

What is claimed is:

1. A power converter comprising:
a high side transistor;
a low side transistor connected to the high side transistor and having a threshold voltage of 0.4 volts or less;
a high side driver connected to the high side transistor to turn on and off the high side transistor; and
a low side driver connected to the low side transistor to turn on and off the low side transistor;
wherein the high side transistor and the low side transistor produce a phase voltage.

2. The power converter of claim 1, wherein:
the low side transistor is coupled to ground; and
a voltage produced by the low side driver to turn off the low side transistor is less than 0 volts.

3. The power converter of claim 2, wherein:
the high side transistor, the low side transistor, the high side driver, and the low side driver are integrated together on a same integrated circuit die.

4. The power converter of claim 3, wherein:
a source of the voltage produced by the low side driver to turn off the low side transistor is also integrated on the same integrated circuit die.

5. The power converter of claim 3, wherein:
the high side transistor and the low side transistor each comprise a plurality of transistor segments distributed within the integrated circuit die; and
the high side driver and the low side driver each comprise a plurality of driver segments distributed within the integrated circuit die and interspersed among the plurality of transistor segments.

6. The power converter of claim 5, wherein:
each driver segment is adjacent to one of the plurality of transistor segments.

7. The power converter of claim 2, wherein:
the high side transistor and the low side transistor are integrated together on a first integrated circuit die; and
the high side driver and the low side driver are integrated together on a second integrated circuit die.

8. The power converter of claim 2, wherein:
the voltage produced by the low side driver to turn off the low side transistor turns off the low side transistor during transients in the phase voltage that have a rise time of 5 ns or less.

9. The power converter of claim 2, wherein:
the voltage produced by the low side driver to turn off the low side transistor is less than −1.0 volts.

10. The power converter of claim 2, wherein:
an impedance between the low side driver and the low side transistor is 0.5 Ohm or less.

11. A method comprising:
turning on a high side transistor to connect a phase node to a high voltage, while a low side transistor having a threshold voltage at 0.4 volts or less is off;
turning off the high side transistor;
turning on the low side transistor to connect the phase node to a low voltage while the high side transistor is off;
turning off the low side transistor; and
repeating the method to generate a phase voltage at the phase node.

12. The method of claim 11, wherein:
the low side transistor is coupled to ground; and
the turning off of the low side transistor turns off the low side transistor with a drive voltage less than 0 volts.

13. The method of claim 12, further comprising:
turning on and off of the high side transistor by a high side driver; and
turning on and off the low side transistor by a low side driver;
wherein the high side transistor, the low side transistor, the high side driver, and the low side driver are integrated together on a same integrated circuit die.

14. The method of claim 13, wherein:
a source of the drive voltage is also integrated on the same integrated circuit die.

15. The method of claim 13, wherein:
the high side transistor and the low side transistor each comprise a plurality of transistor segments distributed within the integrated circuit die; and
the high side driver and the low side driver each comprise a plurality of driver segments distributed within the integrated circuit die interspersed among the plurality of transistor segments.

16. The method of claim 15, wherein:
each driver segment is adjacent to one of the plurality of transistor segments.

17. The method of claim 11, further comprising:
turning on and off the high side transistor by a high side driver; and
turning on and off the low side transistor by a low side driver;
wherein:
the high side transistor and the low side transistor are integrated together on a first integrated circuit die; and
the high side driver and the low side driver are integrated together on a second integrated circuit die.

18. The method of claim 12, further comprising:
the drive voltage turns off the low side transistor during transients in the phase voltage that have a rise time of 5 ns or less.

19. The method of claim 12, wherein:
the drive voltage is less than −1.0 volts.

20. The method of claim 12, further comprising:
turning on and off the low side transistor by a low side driver that produces the drive voltage, wherein an impedance between the low side driver and the low side transistor is 0.5 Ohm or less.
